(19) United States
(12) Patent Application Publication
(10) Pub. No.: US 2024/0380094 A1
(43) Pub. Date: Nov. 14, 2024

(54) FASTENING ARRANGEMENT FOR FASTENING A DEVICE HOUSING OF A DEVICE TO A VEHICLE PANEL OF A MOTOR VEHICLE, AND MOTOR VEHICLE AND DEVICE

(71) Applicant: Continental Automotive Technologies GmbH, Hannover (DE)

(72) Inventors: Florian Fladerer, Riedering (DE); Sebastian Gerbl, Großkarolinenfeld (DE); Rudolf Hildebrand, Holzkirchen (DE)

(73) Assignee: Continental Automotive Technologies GmbH, Hannover (DE)

(21) Appl. No.: 18/688,140

(22) PCT Filed: Jul. 21, 2022
(86) PCT No.: PCT/DE2022/200164

§ 371 Date: Feb. 29, 2024

(30) Foreign Application Priority Data
Aug. 31, 2021 (DE) 10 2021 209 572.0
Oct. 21, 2021 (DE) 10 2021 211 866.6

(51) Int. Cl. H01Q 1/12; B60R 11/00; F16B 5/02; F16B 37/04; H01Q 1/32

(52) U.S. Cl. CPC H01Q 1/1207; B60R 11/00; F16B 5/0208; F16B 37/044; H01Q 1/3275; B60R 2011/004

(57) ABSTRACT

Disclosed is a fastening arrangement of a device housing of a device on a vehicle panel of a motor vehicle, wherein a device housing bears on a first side of the vehicle panel and an assembly appendage of the device is inserted through an assembly opening of the vehicle panel, and a fastening screw protruding from the device housing into the assembly appendage is tightened and pulls a counterpart against an opposite second side of the vehicle panel. Provided in the device housing is a supporting element which transmits a force exerted by the tightening of a screw head of the fastening screw, via the supporting element through a housing wall of the device housing, onto the vehicle panel, and in this way prevents, or at least minimizes, deformations on the housing and/or on a PCB disposed therein, so as to avoid damage due to the introduced screw force.

The invention relates to a fastening arrangement of a device housing of a device or module on a vehicle panel of a motor vehicle. A device housing of the device herein bears on a first side of the vehicle panel (e.g. on the outside) and an assembly appendage of the device is inserted through an assembly opening of the vehicle panel, and a fastening screw is tightened in such a manner that it pulls a counterpart in the assembly appendage against a second side of the vehicle panel, opposite the first side of the vehicle panel (e.g. against the inside of the vehicle panel).

A device can be attached to a vehicle panel of a motor vehicle, for example the outer panel or the so-called outer skin, during the assembly of the motor vehicle, which device is in this way carried or held by the vehicle panel. Examples of such devices are an antenna module, such as a roof antenna module, a side indicator, a wiper motor of a windshield wiper. The assembly of such a device on a vehicle panel should be able to be carried out with only a few hand movements and quickly in order to be able to make the production of the motor vehicle cost-effective. In addition, the components used should be able to be provided in a cost-effective manner. For assembly on one side, it can therefore be provided that provided in the vehicle panel is an assembly opening or through opening through which one part of the device can be inserted in such a way to ensure that the device housing is bearing on one side of the vehicle panel and that the other part of the device that is inserted through said assembly opening forms a mounting for the device on the vehicle panel from the other side. This part of the device that is inserted through the assembly opening is referred to here as the “assembly appendage”. The assembly can provide that the assembly appendage is inserted through the assembly opening and then a fastening screw is tightened, as a result of which a counterpart, for example a plate, is aligned in the assembly appendage and behind the assembly opening (from the point of view of the device housing), conjointly with the periphery of the assembly opening, forms a footing or form-fit on the vehicle panel.

Modules or devices having device housings made of plastics material and in particular having an internal PCBA (printed circuit board assembly), especially in the application as amplifiers/filters/blocking circuits in vehicle (window) antenna systems, are often made without special structural supporting elements for stiffening and/or without metal housings for cost reasons. For the optimized electrical ground connection of the PCBA (printed circuit board assembly) to the vehicle, the printed circuit board is moreover often electrically contacted directly via the fastening screw here, by means of which the device housing is assembled on the vehicle panel. Therefore, the required tightening torques, which are often high, are transferred directly to the PCBA and the plastics material of the device housing. This leads to often impermissible force introduction to the affected components (especially the PCBA and device housing).

If the surface pressure potentially created by the required tightening torque during assembly is excessive here, the plastics material of the device housing and also the PCBA are impermissibly deformed. The result is a destruction or a detachment or breakage of electronic components due to impermissible high mechanical stresses on the device housing. When assembling a motor vehicle, 4 Nm (400 kg) cordless screwdrivers can be used for other components, which poses the risk that these are also used by assembly operators for antenna modules or another device on the vehicle panel, so that said cordless screwdriver pulls a printed circuit board (PCB) and/or a plastic housing part of the device housing into the assembly opening of the vehicle panel (e.g. a roof opening) and deforms said item.

The invention is based on the object of reducing mechanical stresses in a device housing made of plastics material in the fastening arrangement described above and to in this way avoid defects/damage due to a high tightening torque.

The object is achieved by the subject matter of the independent patent claims. Advantageous refinements of the invention are described by the dependent claims, the following description, and the figures.

As a solution, the invention comprises a fastening arrangement of a device housing of a device or module on a vehicle panel of a motor vehicle, wherein the device housing bears on a first side of the vehicle panel and an assembly appendage of the device is inserted through an assembly opening of the vehicle panel (along an insertion direction), and a fastening screw protruding from the device housing into the assembly appendage is tightened and, as a result, pulls a counterpart disposed in the assembly appendage against a second side, opposite the first side, of the vehicle panel. For this purpose, the counterpart per se can have, for example, a threaded bore with a thread in which the fastening screw is rotated. By turning or tightening the fastening screw, the counterpart is pulled toward the second side of the vehicle panel and can establish a form-fit with the periphery of the assembly opening, i.e. with the vehicle panel. Alternatively, the counterpart can have a bore or through opening through which the fastening screw is inserted, and a nut of the fastening screw can push the counterpart in the direction toward the vehicle panel.

The force between the screw head (in the device housing on the first side of the vehicle panel) and the counterpart (on the other side of the vehicle panel) acting due to the tightened fastening screw also acts from the screw head on a housing wall of the device housing on which the screw head bears directly or directly or is supported. In this way, a force can be transmitted via the screw head into the housing wall of the device housing and, as a result, the device housing can be pulled into the assembly opening by deformation or pulled toward the assembly opening. Typically, the assembly opening cannot be reduced because the assembly appendage containing the counterpart must be inserted through said assembly opening. The advantage of using the assembly appendage is that work or assembly during assembling must be carried out on one side, i.e. only from the first side, as the device housing can be placed on the assembly opening, the assembly appendage with the counterpart can be inserted through the assembly opening in the process, and then by tightening the fastening screw from the first side the aligning and the pulling of the counterpart toward the second side of the vehicle panel can also be accomplished or carried out. Due to the size of the assembly opening required by this, however, there is correspondingly little support of the housing wall of the device housing when the screw head presses against the housing wall, because the screw head may have a smaller diameter than the assembly opening. In particular at the forces described at the outset in the range of more than 3 Nm.

In order to nevertheless avoid deformation for the housing wall of the housing, as can be caused by the contact pressure of the screw head of the fastening screw, it is envisaged that provided in the device housing is a supporting element which has along at least one spatial direction parallel to a panel surface of the vehicle panel an external dimension which is larger than an internal diameter of the assembly opening or equal to the internal diameter or smaller than the internal diameter by at most 20 percent in the same spatial direction, and the supporting element in this way transmits a force, exerted by way of the tightening by a screw head of the fastening screw, by way of the supporting element through a housing wall of the device housing onto the vehicle panel and in this way prevents or at least minimizes in particular deformations on the device housing and/or on a PCB disposed therein, so as to avoid damage due to the introduced screw force (force of the fastening screw). In other words, the supporting element perpendicular to the insertion direction (along which the assembly appendage has been inserted into the assembly opening) is wider or larger in at least one spatial direction than the assembly opening per se, so that the supporting element bears on an edge of the assembly opening (with the housing wall therebetween disposed between the supporting element and the vehicle panel). Preferably, the supporting element above the assembly opening bears in a range of at least 40% of the contour of the assembly opening or it protrudes beyond the assembly opening in all directions, thus improving a distribution of force. For example, the supporting element can be designed as a plate or as a disk. The supporting element can have, for example, a bore or through opening through which the fastening screw is inserted so that the screw head presses on the supporting element or bears on it and can transmit the force or the contact pressure to the supporting element and the supporting element (instead of the housing wall) distributes or dissipates the force or the contact pressure laterally, i.e. transversely to the insertion direction, toward the periphery of the assembly opening. However, it has also proved sufficient to achieve an advantage if the external dimension is equal to the internal diameter or smaller than the internal diameter by at most 20 percent. In the latter case, the external dimension of the supporting element is then thus at least 80 percent of the internal diameter. This is still sufficient because the housing wall of the device housing is sufficiently stable over the resulting short distance between the supporting element and the periphery of the assembly hole in order to transmit the force without being damaged and/or significantly deformed as a result. This is particularly true if the fastening screw is tightened to a torque of less than 6 Newton-meters.

The advantage caused by the invention is that independently of a strength of a housing wall, and thus independently of a material choice of the housing wall, it can be established or achieved by providing the supporting element that the force emanating from the screw head can be directed or guided via the supporting element to the periphery of the assembly opening, i.e. toward the vehicle panel. This means that the material of the housing wall itself does not have to be capable of being able to transfer the force to the vehicle panel, and thus transversely to the insertion direction, without deformation.

The invention also encompasses developments that result in additional advantages.

A refinement comprises that the supporting element has a curvature, or convexity, and the supporting element has a shape coding which corresponds to a shape of an enclosure device of the housing in which the supporting element is inserted, and a convexity of the supporting element caused by the curvature points away from the vehicle panel. Said curvature or convexity can result, for example, in that said through opening or bore in the supporting element is drilled by means of a drill and, as a result, the supporting element is indented and then no longer represents, for example, a perfectly flat plate or disks, but the edges of the supporting element are raised, for example, in relation to the center, for example by more than a tenth of a millimeter, but typically less than five tenths of a millimeter. In other words, as a result of the curvature or convexity, the supporting element can have the shape of a disk spring. Although this may be production-related, for example caused by said drilling and/or by punching out the supporting element from a sheet metal, this can be advantageously utilized in that the shape coding ensures that the supporting element by its curvature or convexity in the device housing is aligned in the enclosure or the enclosure device in such a manner that the supporting element acts as a disk spring, i.e. the screw head bears on the highest point of the curvature and the periphery of the supporting element bears on the housing wall. In a device housing made of plastics material, the enclosure device can be formed by means of an injection molding process, for example. For example, this can be a frame and/or detent elements (such as studs or webs, for example), the contour of the latter corresponding to the contour defined by the shape coding. An example of a shape coding may be that the supporting element is designed as a round disk with an extension in one direction, for example, a corner. In general, the shape coding prevents rotational symmetry and/or mirror symmetry in the contour of the supporting element. In particular, it is prevented that the supporting element fits in the enclosure device by way of one side, as well as inverted by way of the other side. By using the shape coding, according to the so-called poka-yoke principle, it can be ensured that a technician inserts the supporting element with the correct spatial orientation into the enclosure device in order to obtain the effect of the disk spring, even if the curvature should not be perceptible to the naked eye. In this way, even a production-related and thus unplanned curvature or convexity of the supporting element can be advantageously utilized.

A refinement comprises that the supporting element is made of a material that is harder and/or stiffer than a material of the housing wall, wherein the supporting element (as an insert element or insert washer) is disposed between the screw head and the housing wall and for this purpose has a through opening through which a threaded bolt or screw shank or threaded shank of the fastening screw is inserted. In particular, a steel (various stainless steels can be selected here by the person skilled in the art, also annealed steels), preferably with a strength between 500 MPa-1200 MPa, has proven advantageous as a material. In that the material of the supporting element can be chosen independently of the material of the housing wall, the housing wall can be optimized for another application, for example tightness and/or production costs, and a sufficiently hard and/or stiff material for dissipating the force from the screw head into the vehicle panel is nevertheless provided by means of the supporting element. In general, the device housing can comprise a plastics material, for example a polycarbonate, as a material, for example. For example, the device housing can be produced by means of an injection molding process.

A refinement comprises that formed on the counterpart is at least one spike which on the second side of the vehicle panel is pressed into a paint of the vehicle panel and/or into a metal of the vehicle panel at a respective puncture site, wherein the supporting element extends opposite the respective puncture site on the first side of the vehicle panel and in this way supports the vehicle panel at the respective puncture site. In general, the counterpart can be designed as a disk or plate, for example. When tightening the fastening screw, the counterpart is pulled by the former against the second side of the vehicle panel, i.e., for example an inside of the vehicle panel. The force acting from the counterpart on the vehicle panel in the process can be utilized to press at least one, for example two or three or four, spikes which are formed on the counterpart into the vehicle panel, so for example through the paintwork or paint of the latter and/or into the metal of the vehicle panel. This allows an electrical connection from an electrical component of the device, such as a printed circuit board, via the fastening screw and the counterpart to the vehicle panel to be established or provided. For this purpose, the counterpart per se is preferably formed from an electrically conducting material, e.g. a metal, in particular steel. In addition to the choice of the material, an advantage can be achieved by a coating, e.g. ZN-NI (zinc-nickel), which in particular ensures corrosion protection when establishing the electric link to the vehicle panel. Because a corresponding mechanical stress acts from a spike onto the vehicle panel at the respective puncture site of the spike, it can be ensured by a correspondingly wide or large supporting element on the opposite first side of the vehicle panel that a mechanical support for the vehicle panel is provided by the supporting element on the first side of the vehicle panel opposite the respective puncture site, thus avoiding that the vehicle panel is dented toward the first side, for example the outside of the vehicle panel. A spike on the counterpart may be designed, for example, as an appendage or tip or claw, which may be formed by bending a corner or tip of the counterpart, for example.

Previously, the supporting element has been described as a plate or disk. However, the supporting element may also have an additional three-dimensional structure to support the dissipation of the force from the screw head to the vehicle panel.

A refinement comprises that formed on at least one edge of the supporting element is a tab which is inserted through a respective slot in the housing wall and bears directly on the vehicle panel. The supporting element can be in this way supported directly on the vehicle panel via the tab and does not have to bear on the material of the housing wall or transmit the force to the vehicle panel via the housing wall. This prevents the housing wall from being crushed between the supporting element and the vehicle panel. The respective tab can be aligned or disposed in particular in such a way that the tab bears in particular opposite at least one puncture site of a respective spike, as has already been described. In other words, a spike on the second side of the vehicle panel thereon respectively presses into a puncture site which represents a support surface or support region for a tab of the supporting element on the opposite first side of the vehicle panel.

A refinement comprises that formed on at least one edge of the supporting element is a collar which is formed by bending a periphery of the supporting element. A collar or an upright or curved edge can be achieved or formed, for example, by deep drawing the supporting element. In that the supporting element is not designed as a flat disk or plate, but at least one edge, in particular two edges or all edges of the supporting element, are upright or bent or crimped in relation to the plate plane, the bending stiffness of the supporting element is increased in comparison to a design as a plate or disk.

A refinement comprises that the supporting element is fastened to the screw head. For example, a screw head in which the supporting element is provided as a disk, for example is pressed onto the latter, thus attached to the screw shank of the fastening screw by means of a press fit, can be provided. In other words, the diameter of the screw head here is increased in such a manner that said screw head has a dimension which is larger than the internal diameter of the assembly opening. The disk shape of the supporting element can be round or rectangular. Alternatively, the supporting element can be inserted into the device housing, e.g. in the described enclosure device.

A refinement comprises that a printed circuit board, PCB, of an electric circuit of the device is held in the device housing by the screw head and/or by the supporting element. In other words, a printed circuit board of a PCBA of an electric circuit is also held by means of the fastening screw. The printed circuit board herein is protected from being indented or deformed in the direction of the assembly opening by the tightening of the fastening screw, because the force emanating from the screw head can be dissipated through the printed circuit board, or directly into the vehicle panel at the periphery of the assembly opening, for example. In other words, in this case, the supporting element also supports the printed circuit board in relation to deformation.

The assembly appendage with the counterpart provided therein must meet two conditions. On the one hand, it must fit through the assembly opening, and on the other hand, during the tightening of the fastening screw, the counterpart must be aligned in relation to the assembly opening in such a way that the counterpart bears on the periphery of the assembly opening, i.e. so that said counterpart can no longer be pulled out of the assembly opening.

A refinement comprises that the assembly opening has an elongate shape with a longitudinal dimension and a transverse dimension smaller in relation to the longitudinal dimension (e.g. a rectangular shape), and the counterpart is shorter than the longitudinal dimension or a diagonal of the elongate shape and longer than the transverse dimension and is mounted in the assembly appendage so as to be rotatable by a rotation angle in a range from 40° to 140°, wherein a rotational position is changed by tightening the fastening screw in such a way that the counterpart is rotated laterally out of lateral walls of the assembly appendage by the tightening and bears on a detent of the assembly appendage. In particular, the assembly appendage is specified in such a way that, when the device is assembled on the vehicle panel, a rotational position of the counterpart, proceeding from an assembly position, by tightening the fastening screw changes so that part of the counterpart is rotated laterally out of lateral walls of the assembly appendage into a holding position by the tightening and bears on a detent of the assembly appendage. In other words, when inserting the assembly appendage, the counterpart is aligned in the latter along the longitudinal dimension or longitudinal direction of the assembly opening, so that the counterpart can be inserted through the assembly opening toward the second side of the vehicle panel. If the fastening screw is then turned or tightened, the counterpart is conjointly rotated until it stops at a detent after rotation in said angular range, and is prevented from further rotation. In this way, however, the counterpart by way of its longitudinal dimension is oriented transversely or obliquely in relation to the assembly opening in such a manner that the counterpart no longer fits the assembly opening (because of the smaller transverse dimension) and thus can establish a form-fit with the peripheries of the assembly opening, i.e. with the vehicle panel. In this way, the fastening of the device to the vehicle panel is able to be carried out by inserting the assembly appendage and tightening the fastening screw. This simplifies the assembly procedure.

A refinement comprises that the supporting element bears on a rib structure configured on the housing wall. A rib structure, or raised structures, for example webs, on which the supporting element can bear can thus be configured on the housing wall. The force to be transmitted from the supporting element to the vehicle panel can be guided by the shape of the rib structure. In comparison to a region of the housing wall surrounding the rib structure, the rib structure also represents a thickening of the former in such a way that the stability or compression resistance of the housing wall can be adjusted by the configuration of the rib structure. In particular, it is provided that appendages on the housing wall are formed by means of the rib structure, which protrude beyond a periphery of the supporting element, i.e. are designed to be wider or with a larger external dimension than the supporting element. This allows the force distribution proceeding from the supporting element into the housing wall to be distributed over an area larger than the area covered by the supporting element per se.

A refinement comprises that the device is designed as a roof antenna module, and that the vehicle panel is a vehicle roof of the motor vehicle. In particular in the case of a vehicle roof, it has proven to be advantageous to hold or fasten devices, in particular a roof antenna, attached thereto using the described fastening arrangement. Particularly in this case, the device comprises the printed circuit board described, which is held in the device housing by means of the fastening screw. An amplifier and/or a filter and/or a blocking circuit for an antenna may be provided in the roof antenna module, for example.

As a further solution, the invention comprises a motor vehicle having a device fastened to a vehicle panel of the motor vehicle, wherein the device is fastened by means of a fastening arrangement according to one of the preceding claims. In other words, a motor vehicle which can be designed, for example, as a passenger motor vehicle or motor truck or as a passenger bus is thus also provided. The motor vehicle can be produced reliably, as the device can be held on the vehicle panel with little additional effort by means of the fastening screw and the counterpart, without causing deformation or damage to the housing of the device and/or a printed circuit board.

As a further solution, the invention comprises a device, in particular a roof antenna module, having a device housing and an assembly appendage disposed thereon for inserting through an assembly opening of a vehicle panel of a motor vehicle along an insertion direction, wherein a fastening screw projecting from the device housing into the assembly appendage is connected to a counterpart disposed in the assembly appendage by way of a thread. Provided in the device housing is a supporting element which, along at least one spatial direction perpendicular to the insertion direction, has an external dimension which is greater than an external dimension of the assembly appendage in the same spatial direction and/or which, along at least one spatial direction transverse or perpendicular to the insertion direction, has an external dimension equal to or greater than a transverse dimension of the assembly appendage and/or than a longitudinal extent of the counterpart. The device can be prepared for assembly in such a way that the counterpart is already provided in the assembly appendage and the fastening screw already protrudes from the device housing into the assembly appendage toward the counterpart. By inserting the assembly appendage into an assembly opening in a vehicle panel of a motor vehicle and tightening or turning the fastening screw, the device can be attached to the vehicle panel, without the device housing and/or a printed circuit board held by means of the fastening screw being damaged due to a torque when tightening the fastening screw. The torque is of course limited here, for example to less than 6 Nm, in particular less than 5 Nm, but can in particular be greater than 3 Nm. The assembly appendage may be formed, for example, as a cage, or by lateral walls, and be designed for holding the counterpart during assembly (before tightening the fastening screw). The person skilled in the art may utilize a correspondingly known solution here.

The invention also includes refinements of the device according to the invention and of the motor vehicle according to the invention, which have features as have already been described in the context of the refinements of the fastening arrangement according to the invention. For this reason, the corresponding refinements of the method according to the invention are not described again here.

The invention also encompasses the combinations of the features of the embodiments described.

An exemplary embodiment of the invention is described hereunder. In the figures:

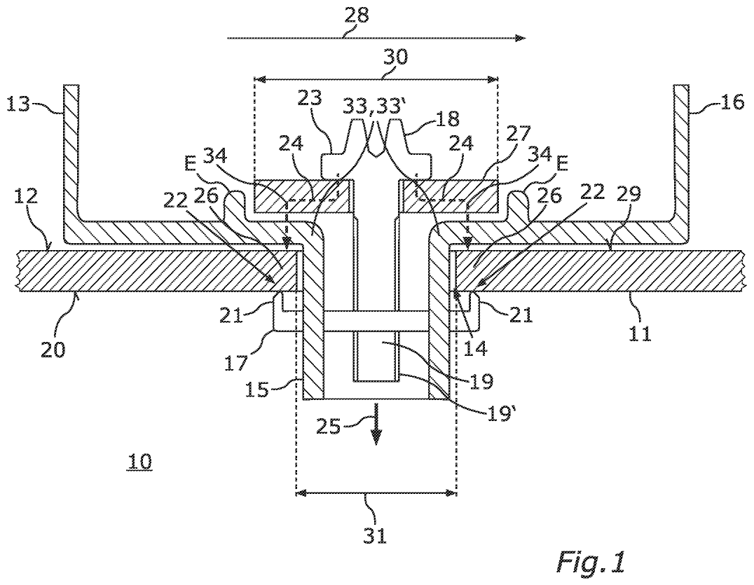

FIG. 1 shows a schematic illustration of a section through part of an embodiment of the motor vehicle according to the invention;

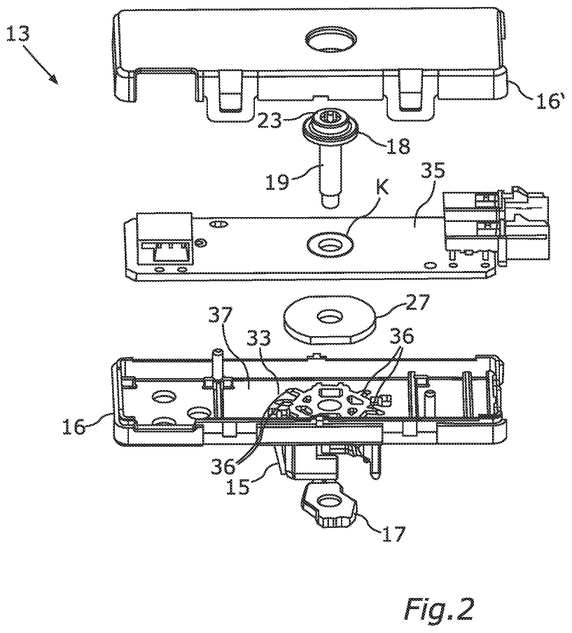

FIG. 2 shows a schematic illustration of an exploded view of an embodiment of the device according to the invention;

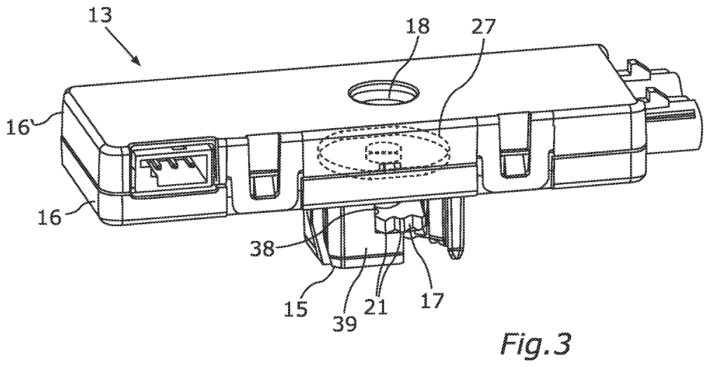

FIG. 3 shows a schematic illustration of the device of FIG. 2 in the assembled state;

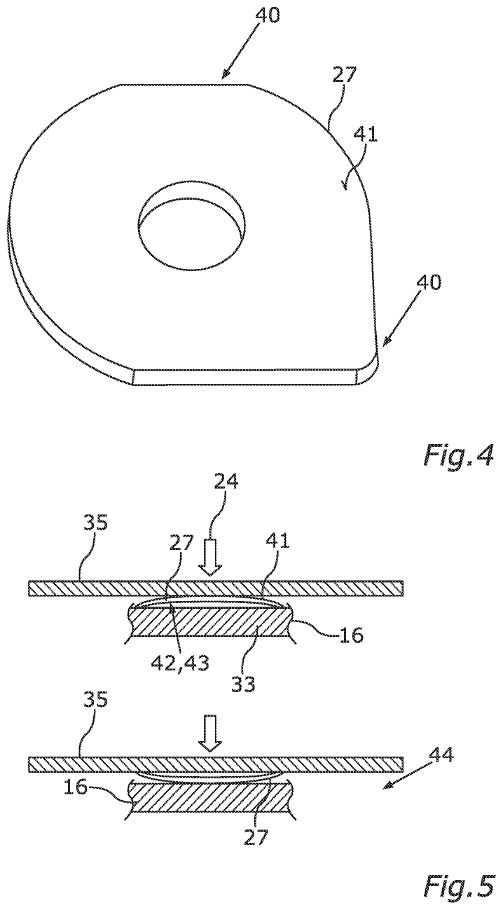

FIG. 4 shows a schematic illustration of a supporting element with shape coding;

FIG. 5 shows a schematic illustration of the supporting element with a curvature;

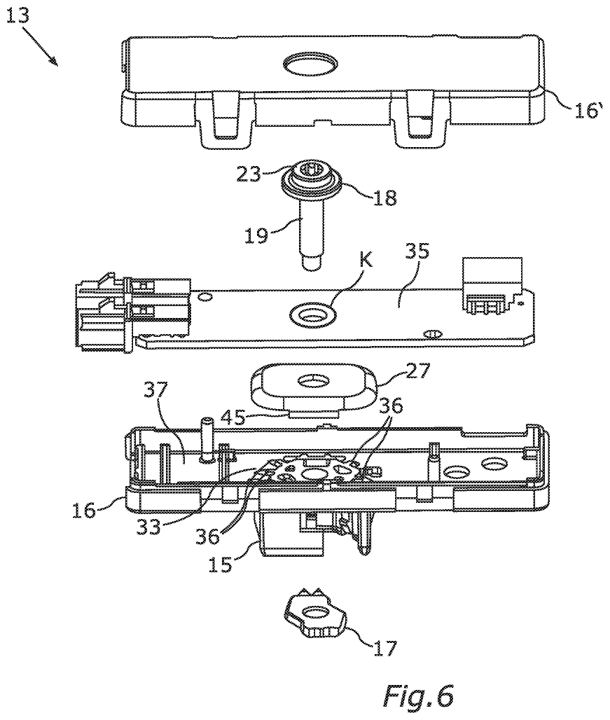

FIG. 6 shows a schematic illustration of an exploded view of another embodiment of the device according to the invention;

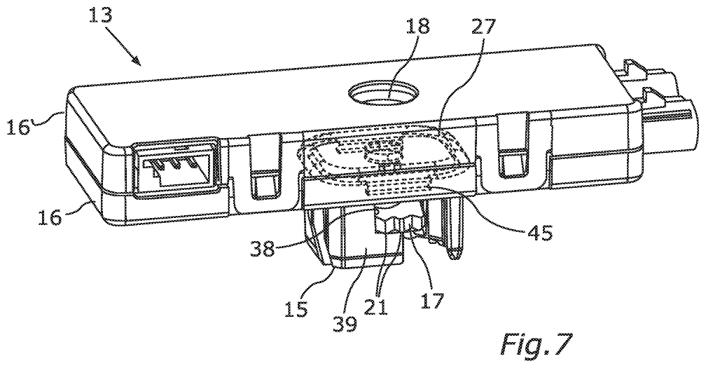

FIG. 7 shows a schematic illustration of the device of FIG. 6 in the assembled state;

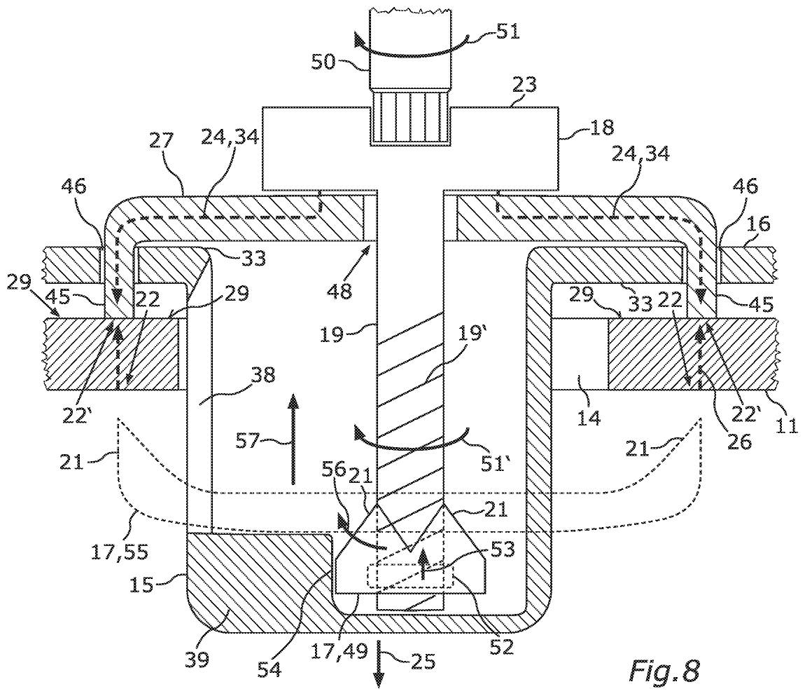

FIG. 8 shows a schematic illustration of a sectional view of an assembly appendage with a counterpart that is pressed into a vehicle panel using spikes;

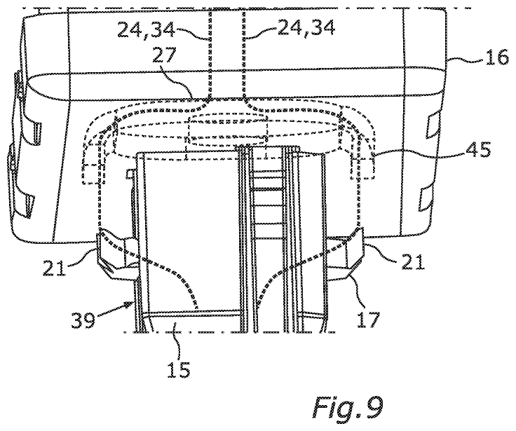

FIG. 9 shows a schematic illustration of the supporting element of FIG. 8 in the assembled state with an illustration of a force flux;

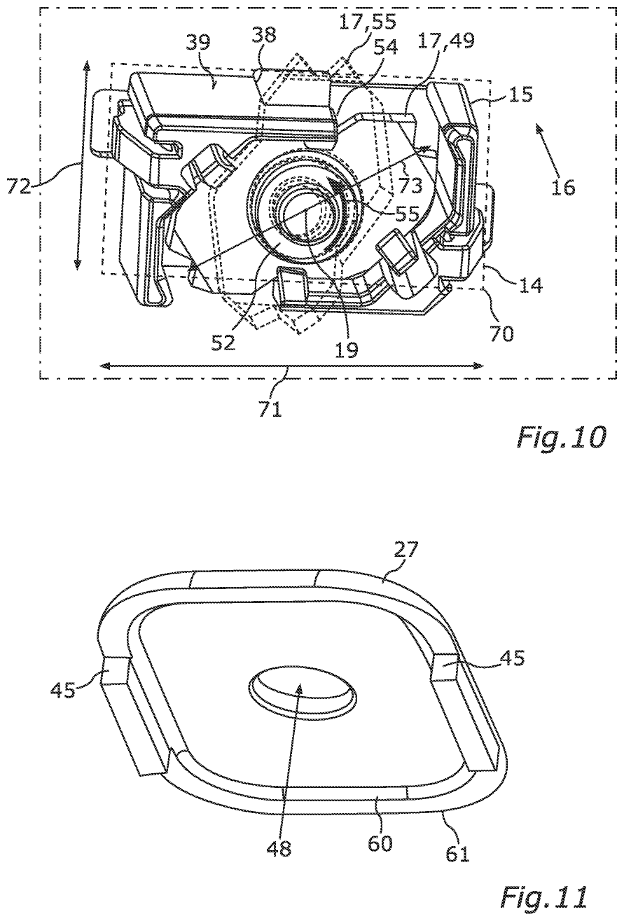

FIG. 10 shows a schematic illustration of the counterpart in an assembly position and a holding position, changing between said positions taking place by tightening a fastening screw; and

FIG. 11 shows a schematic illustration of a supporting element with tabs and collar.

The exemplary embodiment explained below is a preferred embodiment of the invention. In the exemplary embodiment, the described components of the embodiment each represent individual features of the invention that are to be considered independently of one another and that each also refine the invention independently of one another, and can therefore also be considered to be part of the invention individually or in a combination other than that shown. Furthermore, the embodiment described may also be supplemented by further features of the invention that have already been described.

In the figures, functionally equivalent elements are each provided with the same reference signs.

FIG. 1 shows of a motor vehicle 10 a vehicle panel 11 which may be, for example, a vehicle roof of the motor vehicle 10. On the vehicle panel 11, a module or device 13 can be assembled on a first side 12 or outside which module or device 13 may be, for example, an antenna circuit or antenna of the motor vehicle 10. For fastening the device 13 to the vehicle panel 11, the vehicle panel 11 has an assembly opening 14 through which an assembly appendage 15 of the device 13 can be inserted. The assembly appendage 15 can be formed on or fastened to a device housing 16 of the device 13. A counterpart 17, for example a plate or disk of metal, can be disposed in the assembly appendage 15. Provided in the device 13 can be a fastening screw 18 which by tightening or turning, by way of a thread 19′ incorporated in a threaded bolt or screw shank 19, may have pulled the counterpart 17 against a second side 20, or inside, of the vehicle panel 11, as a result of which the device 13 with the vehicle panel 11 is braced or fastened by way of the fastening screw 18 and the counterpart 17. It is shown how the counterpart 17 can have spikes 21 which may have been pressed into the vehicle panel 11 when turning or tightening the fastening screw 18 at a respective puncture site 22. By tightening the fastening screw 18, a screw head 23 can exert a contact force or a contact pressure, or generally a force 24, on the device housing 16. In order that a material of the housing 16 does not have to transfer the force 24 transversely to an insertion direction 25 of the assembly appendage 15 to a periphery 26 of the assembly opening 14, a supporting element 27 which, in at least one transverse direction 28 transverse or perpendicular to the insertion direction 25 and thus parallel to a panel surface 29 of the vehicle panel 11, can have a dimension 30 which is greater than an internal diameter 31 of the assembly opening 14 can be provided. In this way, the supporting element 27 thus protrudes beyond the assembly opening 14 at least along the transverse direction 28, preferably all around the assembly opening. The supporting element 27 thus bears on the respective periphery 26 of the assembly opening 14 on the vehicle panel 11 indirectly via a housing wall 33 of a material 33′ of the device housing 16. FIG. 1 illustrates how the force 24 can thus be transmitted in a force flux 34 from the screw head 23 via the supporting element 27 to the vehicle panel 11. Only a compressive force acts here on the material 33′ of the device housing 16, wherein the material 33′ in the region of the force flux 34 between the supporting element 27 on the one hand and the vehicle panel 11 on the other hand is held or supported in such a way that a deformation or a deflection of the device housing 16 due to the force 24 is avoided, or at least minimized, in comparison to a device housing that instead of a supporting element 27 would only utilize the material 33 of the device housing 16 for transmitting the force 24 from the screw head 23 to the vehicle panel 11.

An enclosure device E, into which the supporting element 27 can be placed, can be formed or provided in the device housing 16. As will yet be explained hereunder (see FIG. 4), it can be achieved by a shape coding that a position or arrangement of the supporting element 27 in the enclosure device E can be unambiguously enforced.

FIG. 2 shows an embodiment of the device 13 in which, as a result of the fastening screw 18, a printed circuit board 35 can additionally be held by means of the fastening screw 18 in the device housing 16. In addition, a housing cover 16′ can belong to the device housing 16, but this does not need to be explained in the context of the functional mode described here. The printed circuit board 35 can have, for example, an electrical contact region K on which the screw head 23 can bear in such a way that an electrical connection between the contact region K and the fastening screw 18 is derived. The contact region K can be formed by a copper layer or aluminum layer of the printed circuit board. In this way, an electrical connection to the vehicle panel 11 (not illustrated in FIG. 1) can be achieved at the puncture sites 22 by way of the fastening screw 18 and the counterpart 17 and the spikes 21 of the latter, described in the context of FIG. 1. The counterpart 17 can be made of an electrically conductive material (electrical conductivity in particular at least 10 000 S/m), in particular a metal, for example steel. The supporting element 27 can also be made of a metal, in particular steel. The device housing 16 can be made of a plastics material, for example a polycarbonate.

A rib structure 36 on which the supporting element 27 can be placed can be designed or provided in the housing wall 33. The rib structure can be a raised structure or molding that protrudes beyond a surrounding surface of the housing wall, or projects from the latter. Due to the rib structure 36, a material thickness of the housing wall 33 in the region of the contact surface of the supporting element 27 on the housing wall 33 can be thickened in comparison to a surrounding region 37, on the one hand. Additionally or alternatively, it can be provided by way of the rib structure 36 to spread or distribute the force 24 acting on the housing wall 33 out of the supporting element 27 to a region on the periphery of the supporting element 27 in such a way that the force 24 can also act on the housing wall 33 beyond a periphery of the supporting element 27.

FIG. 3 visualizes the device 13 in the assembled state, in which the counterpart 17 is pulled against the vehicle panel 11 (not illustrated in FIG. 3) by the fastening screw 18, and spikes 21 are pressed into the vehicle panel 11 at the puncture sites 22. The counterpart 17 herein can bear on a mechanical detent 38 which blocks a rotational movement of the counterpart 17 when turning or tightening the fastening screw 18, wherein the counterpart 17 protrudes from a lateral wall 39 of the assembly appendage 15 and thus represents a form-fit in terms of the assembly opening 14 in the vehicle panel 11.

FIG. 4 shows an embodiment of the supporting element 27 with a shape coding 40, as a result of which rotational symmetry of the supporting element 27 is prevented. It is avoided by the shape coding 40 in particular that the supporting element 27 can be placed in the enclosure device E of an upper side 41 facing downward, thus inverted.

FIG. 5 visualizes how it can be achieved by means of the shape coding 40 (see FIG. 4) that a curvature 42 of the supporting element 27 is aligned in such a manner that, as a result of the supporting element 27, the effect of a disk spring is derived in terms of the transmission of the force 24 to the housing wall 33 of the housing 16, which is to say that the convexity 43 caused by the curvature is oriented away from the vehicle panel 11 or the panel surface of the latter. FIG. 5 for clarification visualizes an incorrect arrangement 44 in which the curvature is oriented toward the vehicle panel 11 in such a way that the force 24 acts on the device housing 16 without the effect of a disk spring.

FIG. 6 illustrates an alternative design embodiment of the device 13, in which the supporting element 27 can have one or more tabs 45 by way of which the supporting element 27 can bear directly on the vehicle panel or the panel surface 29. FIG. 7 visualizes the corresponding arrangement, corresponding to FIG. 3, for the supporting element 27 with the tab or the plurality of tabs 45.

FIG. 8 visualizes how the force 24 can be transmitted in a force flux 34 from the screw head 23 within the supporting element 27 to the vehicle panel 11 by means of the tab 45. For this purpose, the at least one tab 45 can be inserted through a respective slot 46 in the housing wall 33, so that the respective tab 45 bears on the panel surface 29 of the vehicle panel 11. In this way, the supporting element 27 can bear directly on the vehicle panel 11.

The screw shank 19 can be inserted through a through opening 48 in the supporting element 27.

FIG. 8 further visualizes how, during the assembly or the insertion of the assembly appendage 15, the counterpart 17 in the assembly appendage 15 can be positioned through the assembly opening 14 along the insertion direction 25 in an assembly position 49. If the tightening 51 or turning of the fastening screw 18 is then effected by means of a tool 50 during the assembly, a tensile force 53 can be exerted on the counterpart 17 by the thread 19′ of the screw shank 19 via a thread 52 of the counterpart 17. The counterpart 17 may be supported against rotation by an edge 54, but a movement of the counterpart 17 toward the assembly opening 14 results during the further rotation 51′ due to the thread 19′ and the tensile force 53. In the process, the counterpart 17 is moved along the screw shank 19. If the counterpart 17 is then moved past the edge 54, the counterpart 17 can change from the assembly position 49 to a holding position 55 by a rotational movement 56, where said counterpart 17 then stops at the described detent 38 and does not carry out any further rotational movement 56 during the tightening 51 or the further tightening of the fastening screw 18. In this way, the counterpart 17 is “set to transverse” and protrudes from the lateral wall 39 of the assembly appendage 15. The further tightening 51 results in a further movement 57 on the vehicle panel 11 due to the counterpart 17 until the puncture sites 22 are reached, at which the spikes 21 puncture, or are indented into, the vehicle panel 11 during the further tightening 51.

The puncture sites 22 are in particular relative to a support region 22′ of the respective tab 45 on the panel surface 29 of the vehicle panel 11. In other words, the puncture sites 22 and a respective support surface 22′ are disposed opposite one another on the two sides 12, 20 of the vehicle panel 11.

FIG. 9 visualizes an embodiment of the supporting element 27 with the described tabs 45. Additionally or alternatively, a collar 60 can be formed or designed on a periphery or an edge 61 of the supporting element. For example, the collar 60 may be formed by deep drawing a plate from which the supporting element 27 is to be formed. The collar 60 is in particular encircling. A flexural stiffness can advantageously be adjusted, defined or increased by the collar 60.

FIG. 10 shows once again from another perspective the assembly position 49 and the holding position 55 of the counterpart 17 in the assembly appendage 15.

It is illustrated how the assembly opening 14 can have an elongate shape 70, in which a longitudinal dimension 71 is larger than a transverse dimension 72. For example, the shape 70 can be a rectangular shape. A longitudinal extent 73 of the counterpart 17 may be smaller than the longitudinal dimension 71 or a diagonal of the assembly opening 14 and greater than the transverse dimension 17. In the holding position 55, the counterpart 17 with its longitudinal extent 73 can be aligned parallel to the transverse dimension 72. In this way, in the holding position 55, the counterpart 17 can no longer be pulled out of the assembly opening 14 counter to the insertion direction 25, and the described form-fit between the counterpart 17 and the vehicle panel 11 is derived. On the other hand, in the assembly position 49, the longitudinal extent 73 may be aligned such that the counterpart 17 in the assembly appendage 15 can be inserted through the assembly opening 14. The change from the assembly position 49 to the holding position 55 results from the described rotation 51′ by, for example, 45° or 90°, or generally in the range between 40° and 140°.

Thus, a preferably metallic supporting element is introduced under the PCBA for distributing the force introduced by the fastening screw. This distributes the force over a larger surface area and prevents/reduces a local deflection of the PCB and device housing. This measure is especially necessary for fasteners (indirect threaded connection) with large assembly openings in the vehicle body and high tightening torques.

An alternative solution is to install this supporting element above the PCBA, directly under the screw head, or to correspondingly increase the size of the screw head itself (e.g. as a formed disk or as a press-fitted disk). The idea can be used for screwed-on housings with and without PCBA made of plastics material, in which the permissible stress would be exceeded.

When installing for other components, 4 Nm (400 kg) cordless screwdrivers can now be used, which no longer carries the risk that said cordless screwdriver pulls the printed circuit board and/or plastic housing part (cage) of the antenna module into the roof opening, and deforms said printed circuit board and/or plastic housing part (problem at more than 4 Nm, i.e. 400 kg).

A supporting element minimizes deformation of the housing. For this purpose, it protrudes in particular laterally (at least in one dimension) beyond the motor vehicle roof assembly opening and is formed as:
a washer-like element, i.e. as a plate or disk (preferred solution);
the neck of the screw head is larger than the assembly opening;
   an attachment with lateral bent tabs which press into slots (e.g. in the plastic housing part or cage) under pressure and which could bear directly on the vehicle panel in order to transfer the pressure onto the latter (see FIG. 8);
      as a washer or large screw head, or intermediate part.

Overall, the example shows how a supporting element for distributing a contact pressure of a screw head on a housing wall and a PCB can be provided.

### LIST OF REFERENCE SIGNS

10 Motor vehicle
11 Vehicle panel
12 First side
13 Device
14 Assembly opening
15 Assembly appendage
16 Housing cover
16 Device housing
17 Counterpart
17 Transverse dimension
19 Thread
19 Screw shank
20 Second side
21 Spike
22 Puncture site
23 Screw head
24 Force
25 Insertion direction
26 Periphery
27 Supporting element
28 Transverse direction
29 Panel surface
30 Dimension
31 Internal diameter
33 Housing wall
33′ Material
34 Force flux
35 Printed circuit board
36 Rib structure
37 Surrounding region
38 Detent
39 Lateral wall
40 Shape coding
41 Upper side
42 Curvature
43 Convexity
44 Incorrect arrangement
45 Tab
46 Slot
48 Through opening
49 Assembly position
50 Tool
51 Tightening
52 Thread
53 Tensile force
54 Edge
55 Holding position
56 Rotational movement
57 Movement
60 Collar
61 Edge
70 Shape
71 Longitudinal dimension
72 Transverse dimension
73 Longitudinal extent

1. A fastening arrangement of a device housing of a device on a vehicle panel of a motor vehicle, wherein a device housing bears on a first side of the vehicle panel and an assembly appendage of the device is inserted through an assembly opening of the vehicle panel, and a fastening screw protruding from the device housing into the assembly appendage is tightened and, as a result, pulls a counterpart disposed in the assembly appendage against a second side, opposite the first side, of the vehicle panel, wherein provided in the device housing is a supporting element which, along at least one spatial direction parallel to a panel surface of the vehicle panel, has an external dimension which is larger than an internal diameter of the assembly opening, or equal to the internal diameter, or smaller than the internal diameter by at most 20 percent, in the same spatial direction, and the supporting element in this way transmits a force exerted by the tightening of a screw head of the fastening screw, via the supporting element through a housing wall of the device housing, onto the vehicle panel.

2. The fastening arrangement as claimed in claim 1, wherein the supporting element has a curvature, and the supporting element has a shape coding that corresponds to a shape of an enclosure device of the device housing into which the supporting element is placed, and a convexity of the supporting element caused by the curvature points away from the vehicle panel.

3. The fastening arrangement as claimed in claim 1, wherein the supporting element is made of a material that is harder and/or stiffer than a material of the housing wall, wherein the supporting element is disposed between the screw head and the housing wall and for this purpose has a through opening through which a screw shank of the fastening screw is inserted.

4. The fastening arrangement as claimed in claim 1, wherein formed on the counterpart is at least one spike which on the second side of the vehicle panel is pressed into a paint of the vehicle panel and/or into a metal of the vehicle panel at a respective puncture site, wherein the supporting element extends opposite the respective puncture site on the first side of the vehicle panel and in this way supports the vehicle panel at the respective puncture site.

5. The fastening arrangement as claimed in claim 1, wherein formed on at least one edge of the supporting element is a tab which is inserted through a respective slot in the housing wall and bears directly on the vehicle panel.

6. The fastening arrangement as claimed in claim 1, wherein configured on at least one edge of the supporting element is a collar which is formed by bending a periphery of the supporting element.

7. The fastening arrangement as claimed in claim 1, wherein the supporting element is fastened to the screw head.

8. The fastening arrangement as claimed in claim 1, wherein a printed circuit board, PCB, of an electric circuit of the device is held in the device housing by the screw head and/or by the supporting element.

9. The fastening arrangement as claimed in claim 1, wherein at least one of the assembly opening and the assembly appendage has an elongate shape with a longitudinal dimension and a transverse dimension smaller in relation to the longitudinal dimension, and the counterpart is shorter than the longitudinal dimension or a diagonal of the elongate shape and longer than the transverse dimension, and is mounted in the assembly appendage so as to be rotatable by a rotation angle in a range from 40° to 140°, wherein the assembly appendage is specified in such a way that, when the device is assembled on the vehicle panel, a rotational position of the counterpart, proceeding from an assembly position, by tightening the fastening screw changes so that part of the counterpart is rotated laterally out of lateral walls of the assembly appendage into a holding position by the tightening and bears on a detent of the assembly appendage.

10. The fastening arrangement as claimed in claim 1, wherein the supporting element bears on a rib structure configured on the housing wall.

11. The fastening arrangement as claimed in claim 1, wherein the device is a roof antenna module, and the vehicle panel is a vehicle roof of the motor vehicle.

12. A motor vehicle having a device fastened to a vehicle panel of the motor vehicle, wherein the device is fastened by a fastening arrangement as claimed in claim 1.

13. A device, comprising a device housing and an assembly appendage disposed thereon for insertion through an assembly opening of a vehicle panel of a motor vehicle along a designated insertion direction, wherein a fastening screw protruding from the device housing into the assembly appendage is connected to a counterpart disposed in the assembly appendage by a thread, wherein provided in the device housing is a supporting element which, along at least one spatial direction transverse or perpendicular to the designated insertion direction, has an external dimension which is equal to or greater than a transverse dimension of the assembly appendage and/or than a longitudinal extent of the counterpart.

14. The device as claimed in claim 13 wherein the device is a roof antenna module.

15. The fastening arrangement as claimed in claim 2, wherein the supporting element is made of a material that is harder and/or stiffer than a material of the housing wall, wherein the supporting element is disposed between the screw head and the housing wall and for this purpose has a through opening through which a screw shank of the fastening screw is inserted;
wherein formed on the counterpart is at least one spike which on the second side of the vehicle panel is pressed into a paint of the vehicle panel and/or into a metal of the vehicle panel at a respective puncture site, wherein the supporting element extends opposite the respective puncture site on the first side of the vehicle panel and in this way supports the vehicle panel at the respective puncture site;
wherein formed on at least one edge of the supporting element is a tab which is inserted through a respective slot in the housing wall and bears directly on the vehicle panel,
wherein configured on at least one edge of the supporting element is a collar which is formed by bending a periphery of the supporting element;
wherein the supporting element is fastened to the screw head;
wherein a printed circuit board, PCB, of an electric circuit of the device is held in the device housing by the screw head and/or by the supporting element;
wherein at least one of the assembly opening and the assembly appendage has an elongate shape with a longitudinal dimension and a transverse dimension smaller in relation to the longitudinal dimension, and the counterpart is shorter than the longitudinal dimension or a diagonal of the elongate shape and longer than the transverse dimension, and is mounted in the assembly appendage so as to be rotatable by a rotation angle in a range from 40° to 140°, wherein the assembly appendage is specified in such a way that, when the device is assembled on the vehicle panel, a rotational position of the counterpart, proceeding from an assembly position, by tightening the fastening screw changes so that part of the counterpart is rotated laterally out of lateral walls of the assembly appendage into a holding position by the tightening and bears on a detent of the assembly appendage; and
wherein the supporting element bears on a rib structure configured on the housing wall.

16. The fastening arrangement as claimed in claim 15, wherein the device is a roof antenna module, and the vehicle panel is a vehicle roof of the motor vehicle.
